(19) United States
(12) Patent Application Publication
(10) Pub. No.: US 2016/0071096 A1
(43) Pub. Date: Mar. 10, 2016

(54) Method and System for Securing Cryptocurrency Wallet

(71) Applicant: Andrew Rosca, Stamford, CT (US)

(72) Inventor: Andrew Rosca, Stamford, CT (US)

(21) Appl. No.: 14/848,294

(22) Filed: Sep. 8, 2015

Related U.S. Application Data
(60) Provisional application No. 62/047,608, filed on Sep. 8, 2014.

(51) Int. Cl. G06Q 20/36; G06Q 20/40; G06Q 20/38

(52) U.S. Cl. CPC G06Q 20/3674; G06Q 20/382; G06Q 20/401; G06Q 2220/00

(57) ABSTRACT

Disclosed are a system and method for securing an online wallet by separating a first server hosting a cryptocurrency transaction website from a second server executing the cryptocurrency transactions within a private network. In a method of securing such cryptocurrency transactions, the first server receives a transaction request from a user to execute a transaction with a cryptocurrency stored in an online wallet. The first server then generates a request message and embeds at least a portion of the transaction request into the request message. The first server places the request message in a message queue and transmits the request message to the second server through the message queue. The second server receives the request message, extracts the transaction request and executes a cryptocurrency transaction based on the transaction request. The second server generates a response message and transmits the response message to the first server through the message queue.

### CROSS REFERENCE TO RELATED APPLICATIONS

This application is a non-provisional application claiming priority to co-pending U.S. provisional patent application Ser. No. 62/047,608, filed on Sep. 8, 2014, which is incorporated herein for all purposes.

### FIELD OF TECHNOLOGY

This disclosure relates generally to online wallets and, more particularly, to a system and method for securing an online wallet, such as an online wallet for cryptocurrency, and for securing transactions involving online wallets.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

In recent years, cryptocurrencies have started to see wide adoption all over the world. Traditionally, cryptocurrencies refer to virtual currency serving as a medium of exchange designed to utilize cryptography for security and anti-counterfeiting measures. One example of cryptocurrency is Bitcoin, although many other types of virtual currency exist.

Cryptocurrency funds are stored in encrypted files called online wallets or, simply, wallets. One vulnerability of these wallets is that a malicious user with physical access to the machine on which the wallet resides can, under the right circumstances, gain access to the wallet and transfer all funds to a third party account, effectively stealing the funds. Wallets can be encrypted, so they can only be accessed and used in the presence of a secret key or password. Under these circumstances, even a malicious user with physical access to the wallet file may have difficulty utilizing it and stealing the funds contained within.

However, if the wallet is intended to be used by an automated system, such as a website, it is necessary to either leave the wallet unencrypted or store the secret key or password in a configuration file, in a piece of code, or otherwise make it accessible to the automated system. A malicious user with physical access to the server can thus much more easily gain access to the wallet if the wallet is normally accessed by an automated system.

This problem exists in particular for large exchanges, marketplaces, and other systems, which hold funds for a large number of users. Many of these systems maintain a single wallet which holds all customer funds and which is stored on a web server that hosts the customer-facing website, which makes it particularly vulnerable to attacks from the Internet. Since the website needs to access the wallet, any passwords or other security methods are accessible to the security account under which the website itself operates. Recently, there has been a number of high profile cases in which this type of setup has led to the theft of large amounts of cryptocurrency.

Accordingly, there is a need in the art to enhance security measures for online wallets, as well as to improve security of transactions involving virtual currency, such as cryptocurrency, or involving online wallets.

### SUMMARY

This section is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

The present disclosure relates a system and method for securing an online wallet, such as an online wallet for cryptocurrency, and for securing transactions involving online wallets. The proposed system and method involve physically separating a server, which hosts a cryptocurrency transaction website, from a server, which hosts the online wallet and performs cryptocurrency transactions. One of the advantages of the present technology is that the server, on which the online wallet resides, is not accessible through the Internet or other publically available network. This may prevent unauthorized users from gaining access to the online wallet.

According to one aspect of this disclosure, a method of securing cryptocurrency transactions involves receiving, through a first server, a transaction request of a user to execute a transaction with a cryptocurrency stored in an online wallet. The first server hosts a website accessible to a plurality of users through the Internet or manages an Internet interface accessible to the plurality of users through the Internet. The first server generates a request message and embeds at least a part of the transaction request of the user into the request message. Then, the first server places the request message in a message queue. Furthermore, the first server or a computing device transmits the request message to a second server using the message queue. The second server is accessible only through a private network and is configured to read messages from the message queue. The second server receives the request message and extracts the transaction request from the request message. The second server then executes the transaction of the cryptocurrency based on the transaction request. The second server generates a response message comprising a result of the transaction of the cryptocurrency. Thereafter, the second server places the response message in the message queue and transmits the response message to the first server using the message queue.

In another aspect of this disclosure, a system for securing cryptocurrency transactions comprises a first server and a second server. The first server is configured to receive a transaction request from a user to execute a transaction with a cryptocurrency stored in an online wallet. The first server is also configured to generate a request message and embed at least a part of the transaction request in the request message. The first server is further configured to place the request message in a message queue and transmit the request message to the second server using the message queue. The second server is accessible only through a private network and is configured to read messages from the message queue. The second server is configured to receive the request message from the message queue and extract the transaction request from the request message. The second server is also configured to generate a response message comprising a result of the transaction of the cryptocurrency. The second server is further configured to place the response message in the message queue and transmit the response message to the first server through the message queue.

In yet another aspect of this disclosure, a method for securing cryptocurrency transactions involves a first server receiving a transaction request from a user to execute a transaction with cryptocurrency stored in an online wallet associated with the user. The first server generates a request message and embeds at least a part of the transaction request of the user into the request message. The first server places the request message in a message queue and transmits the request message to a second server using the message queue. The second server is accessible only through a private network and is configured to read messages from the message queue. The second server transmits and the first server receives a response message through the message queue, the response message comprising a result of the transaction.

The methods and systems disclosed herein may be implemented in any means for achieving various aspects, and may be executed in a form of a non-transitory machine-readable medium embodying a set of instructions that, when executed by a machine, causes the machine to perform any of the operations disclosed herein.

Additional objects, advantages, and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a block diagram of a system architecture for securing cryptocurrency transactions comprising a web server, a wallet server, and a message queue, according to one or more embodiments.

FIG. 2 is a block diagram illustrating an embodiment of the system architecture of FIG. 1 in which the message queue resides on the web server, according to one or more embodiments.

FIG. 3 is a block diagram illustrating an embodiment of the system architecture of FIG. 1 in which the message queue resides within the private network with the wallet server, according to one or more embodiments.

FIG. 4 is a block diagram illustrating the system architecture of FIG. 1 in which one or more administrative servers communicate with the wallet server, according to one or more embodiments.

FIG. 5 is a process flowchart illustrating a method of securing cryptocurrency transactions, according to one or more embodiments.

FIG. 6 is a block diagram illustrating an exemplary server architecture, according to one or more embodiments.

Other features of the present embodiments will be apparent from the accompanying drawings and from the detailed description that follows.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments may be combined, other embodiments may be utilized, or structural, logical, and operational changes may be made without departing from the scope of what is claimed. The following detailed description is, therefore, not to be taken in a limiting sense, and the scope is defined by the appended claims and their equivalents.

As outlined above, the present technology provides for a secure online wallet for cryptocurrencies (e.g., Bitcoin), virtual currencies, or any other monetary or non-monetary instruments. In this disclosure, the term “cryptocurrency” shall mean a digital representation of a value that can be digitally traded. For simplicity, the present disclosure is limited to cryptocurrencies and online wallets, although the principles of the present technology may be applied to any suitable currencies, monetary or non-monetary instruments, as well as to any online storage or web service for storing and transacting currencies, monetary or non-monetary instruments.

According to one or more embodiments, a system for securing an online wallet includes at least two servers or their functional equivalents (e.g., one or more computers with network interface). The first server is intended to host a website or include an internet interface configured to enable users to create and submit requests for performing cryptocurrency transaction involving one or more online wallets. The internet interface may include Application Programming Interface (API), content management framework, function calls, software modules, and/or other web applications as needed to implement data transmission between the first server and intended users. For example, API interface may enable the users to use mobile applications or software applications for making information requests and receiving information responses. Accordingly, the first server is accessible to public through the Internet. On the other hand, the second server is intended to store one or more online wallets and interface with a secure private network only, except as necessary for transaction data to be exchanged with the cryptocurrency network. The second server is heavily secured and protected from being accessed through the Internet or through any other public or non-public communications network (i.e. through an intranet or private network). For simplicity, the first server is hereinafter referred to as “web server” and the second server is hereinafter referred to as “wallet server.”

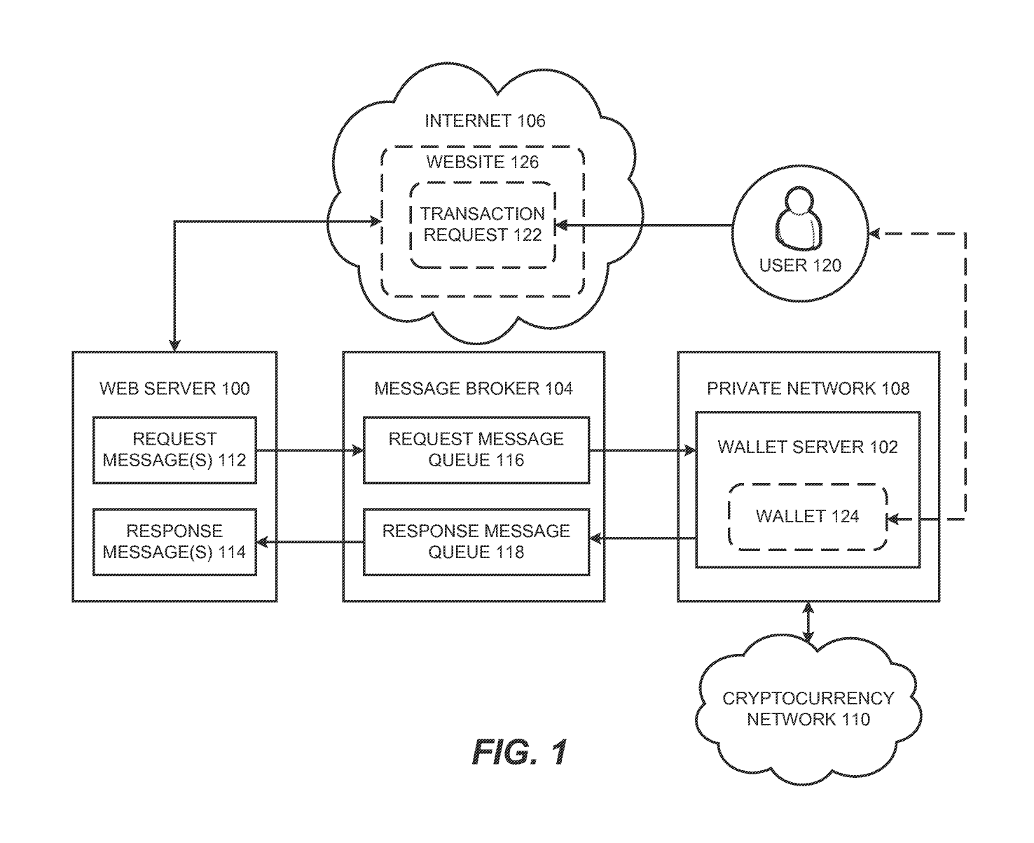

Reference is now made to FIG. 1, which is a block diagram illustrating a system architecture for securing cryptocurrency transactions comprising a web server 100, a wallet server 102, and a message broker 104, according to one or more embodiments. As shown in FIG. 1, the web server 100 is communicatively coupled directly to the Internet 106 and indirectly to a private network 108. The private network 108 includes the wallet server 102, which is configured to communicate with a cryptocurrency network 110. The cryptocurrency network 110 is suitable for enabling cryptocurrency transactions and may include one or more public or non-public communication networks.

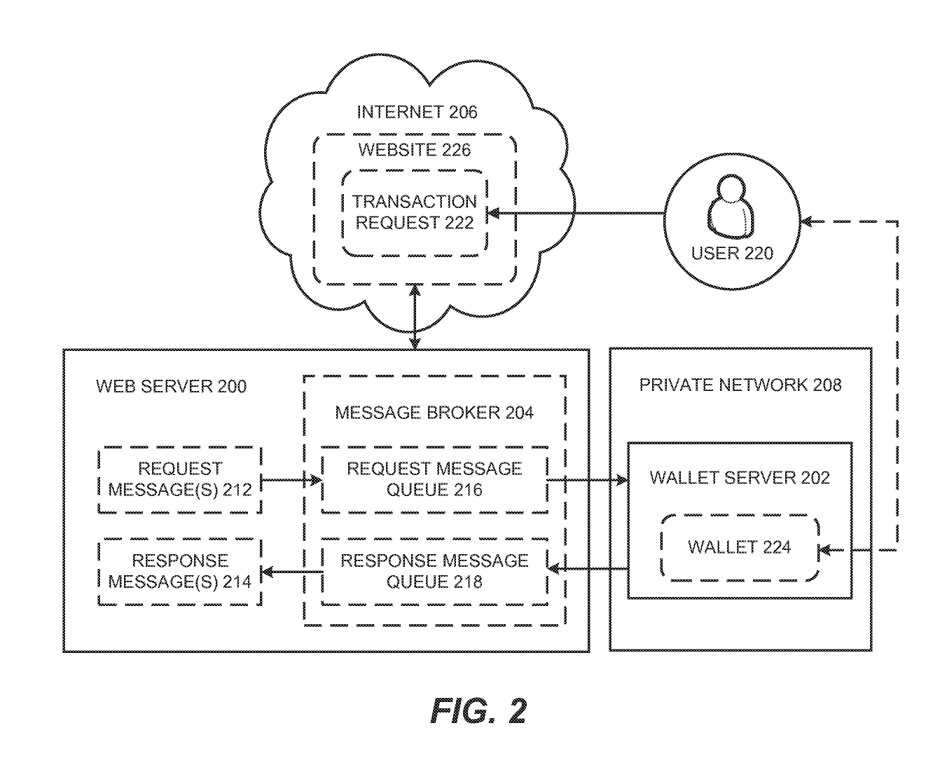

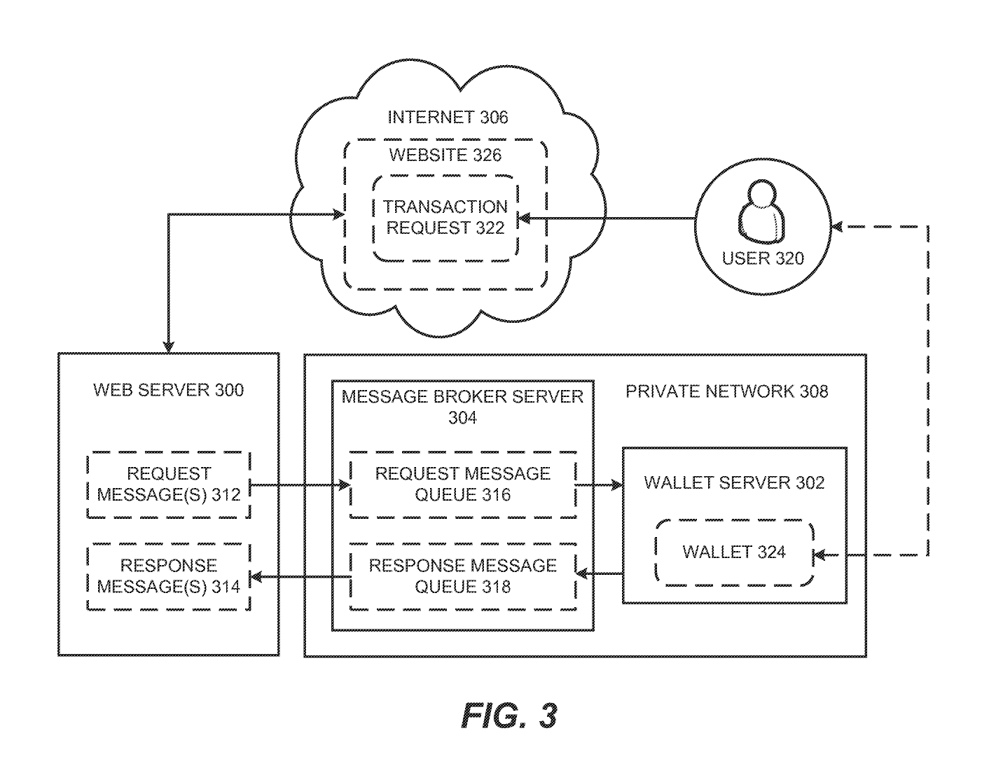

The private network 108 is additionally configured to communicate with the web server 100 through a message broker 104. In some embodiments, message broker 104 may include an intermediary software module, which translates a message from a formal messaging protocol of a sender to a formal messaging protocol of a receiver. In certain embodiments, the message broker 104 may utilize a synchronous or asynchronous message queuing protocol. Accordingly, communication between endpoints may comprise receiving and communicating a series of request messages 112 and response messages 114 through a request message queue 116 and a response message queue 118, respectively, of the message broker 104. As such, the message broker 104 may enable bidirectional communication of the request messages 112 and the response messages 114 between the web server 100 and the wallet server 102. In another embodiment, the message broker 104 resides on the web server 100 (as shown in FIG. 2). In one embodiment, the message broker 104 resides on a separate server within the private network 108 (as shown in FIG. 3). In some embodiments, message broker 104 may refer to a single queue, which allows for message transfer in both directions. Those skilled in the art will appreciate that these bidirectional queues (i.e. using request message queue 116 and a response message queue 118 or a combined request message queue and response message queue) can both be suitable for implementation in the present technology.

In one embodiment, the system operates as follows: first, a user 120 of a data processing device communicatively coupled to the web server 100 through the Internet 106 may initiate a cryptocurrency transfer by communicating a transaction request 122 to the web server 100. In this embodiment, the user 120 may desire to access his wallet 124 (maintained by the wallet server 102) to perform cryptocurrency transactions through a website 126 hosted by the web server 100 (e.g. the user 120 wants to transfer funds to a different account).

Next, the web server 100 may optionally perform various security checks, such as: authenticating the user, validating login credentials (e.g. username, password, private key, etc.) to determine if the requested transaction is properly authorized, and other security checks. Any type and number of security checks may be employed and are within the scope of the exemplary embodiments described herein. If the security checks are successfully complete, the web server 100 posts a request message 112 to the request message queue 116 of the message broker 104. The request message 112 comprises the transaction request 122

Next, the wallet server 102 reads the request message 112 from the request message queue 116 of the message broker 104 and extracts the transaction request 122. Then, the wallet server 102 executes the transaction request 122 (e.g. perform the desired cryptocurrency transaction).

Next, the wallet server 102 places a response message 114 in the response message queue 118 of the message broker 104 comprising the results of the performed cryptocurrency transaction (e.g. success, failure, need more authentication etc.). The web server 100 reads the result of the performed cryptocurrency transaction from the response message 114 and performs any further operations as needed (e.g. notifying the user, making a log input, updating a profile of the user, etc.).

It is important to note that the web server 100 has no knowledge of the IP address, or any other details pertaining to the wallet server 102. The web server 100 and the wallet server 102 may only communicate through the message broker 104. As such, there is no direct connection between the web server 100 and the wallet server 102. Therefore, a malicious user who successfully compromises the security of the web server 100 may not utilize a simple way of accessing the wallet server 102. Since the types of request message that the wallet server 102 accepts may be limited (e.g. it only accepts requests for transferring between internal accounts), the types of operations that a malicious user may perform through the web server 100 may be limited.

Moreover, the message broker 104 and the wallet server 102 may not be accessible from the Internet 106 at all. While the web server 100 may require access to the message broker 104 in order to post a request message 112 to the request message queue 116 and read response messages from the response message queue 116, this can be accomplished via a private network inaccessible through the Internet 106. For example, the wallet server 102 and the message broker 104 may be communicatively coupled through an intranet (e.g. a local area network—LAN, or virtual private network—VPN) that is only accessible locally (or remotely) by the web server 100.

Reference is now made to FIG. 2, which is a block diagram illustrating an alternate embodiment of the system architecture of FIG. 1 in which the message broker 204 resides on the web server 200. Though the wallet server 202 may reside on the private network 208, the message broker 204 may reside within the web server 200. Alternately, the message broker 204 may reside on a server that may share a network with the web server 200. In either embodiment, the wallet server 202 is sequestered and may not communicate to any external data processing device except through the message broker 204 shared with the web server 200.

Hence, provided that the message broker 204 resides on the web server 200 (or within the same network as the web server 200), the wallet server 202 can retrieve request messages from the request message queue 216 of the message broker 204 and communicate response messages through the response message queue 218 of the message broker 204 without the web server 200 having any knowledge of where the wallet server 202 resides. It is only necessary for the wallet server 202 to know the IP address of the web server 200, which would be the case if the wallet server 202 and the web server 200 were constituents of a private intranet (i.e. not accessible by the Internet). Because the web server 200 may have multiple IP addresses, the public IP address that the web server 200 listens for transaction requests can be different from the one on which the message broker 204 operates (e.g., a LAN IP address).

Reference is now made to FIG. 3, which is a block diagram illustrating an embodiment of the system architecture of FIG. 1 in which the message queue 304 of FIG. 2 is hosted by a message broker server 304 residing within the private network 308 with the wallet server 302, according to one or more embodiments. In one embodiment, a message broker server 304 may also be sequestered from the Internet-accessible web server 300. Such a system architecture may further enhance security by preventing malicious users who compromise the network of the web server 300 from further accessing the request message queue 316 and/or the response message queue 318.

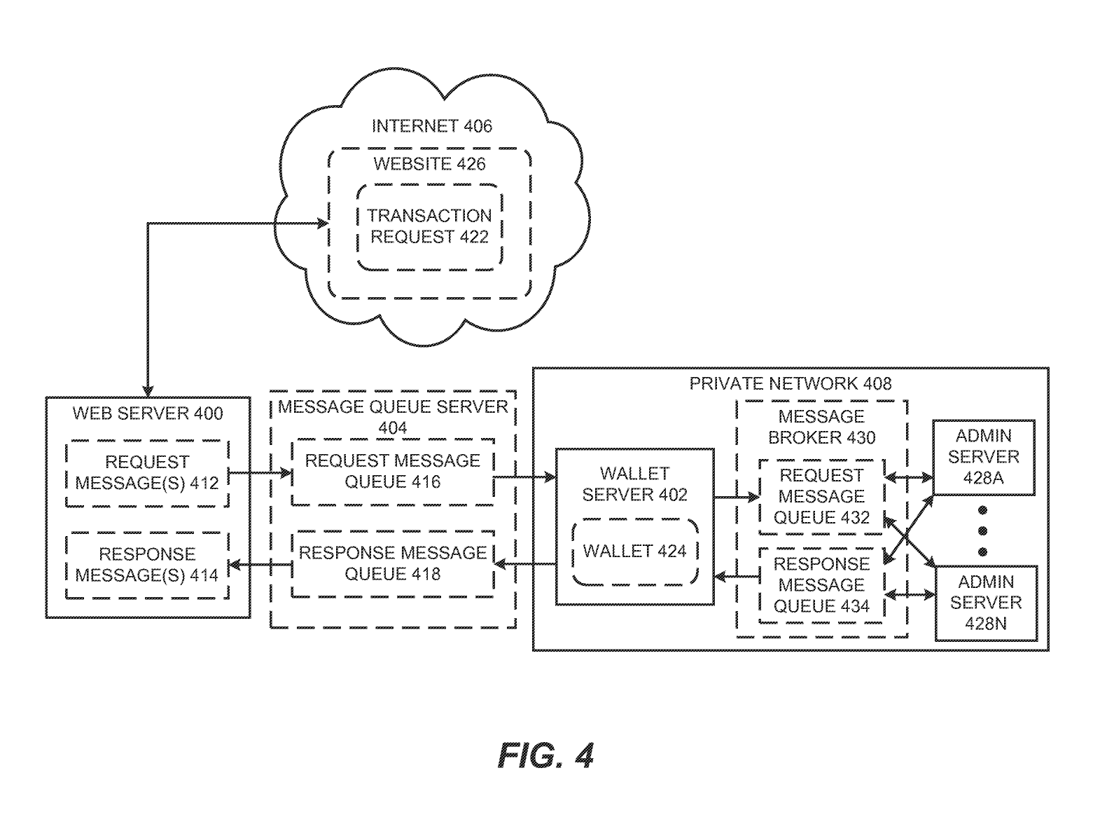

Reference is now made to FIG. 4, which is a block diagram illustrating the system architecture of FIG. 1 in which one or more administrative servers 428A-N communicate with the wallet server 424, according to one or more embodiments. Because the type of operations that can be performed by the web server 400 is limited, the system allows for additional servers with varying security configurations. FIG. 4 shows another embodiment of the system architecture of FIG. 1 in which there may be one or more admin servers 428A-N. The admin server(s) 428A-N may execute a user interface intended for use by system administrators. The admin server(s) 428A-N may either reside within the same private network 408 as the wallet server 402 or interface with the wallet server 402 through another message broker 430 which may comprise another request message queue 432 and another response message queue 434. Thus the wallet server 402 can accept certain, less dangerous request messages 412 from the web server 400 via the request message queue 416 and receive request messages, which require a higher level of approval, via the request message queue 432 from the admin server 428A.

In one embodiment, the wallet server 402 may only accept transactions from the web server 400 that transfer funds internally within the wallet server 402 (e.g. such as when funds are transferred from an online wallet of one particular user to another online wallet of the same user or another user). With proper accounting and logging procedures in place, if a malicious user compromises the security of the web server 400, gains access to the web server 400, and successfully performs an unauthorized transfer of funds (e.g. when funds are transferred from an online wallet of one particular user to another online wallet of a different user), such actions can be detected and reversed. By contrast, in a traditional system in which the web server 400 has direct access to the wallet server 402, a malicious user may transfer funds to one or more external accounts, in which case, if the funds are a cryptocurrency, the transfer may be irreversible and often untraceable.

In one embodiment, the wallet server 424 may record all transaction requests transmitted to it from the web server 400 in a transaction log. The wallet server 402 may transmit the transaction log to the administrative server 428A. The administrative server 428A may create a request message comprising one or more reversal requests. The reversal requests may be configured to reverse one or more malicious transactions of cryptocurrency performed by the wallet server 402. Accordingly, the system architecture of FIG. 4 may provide a facility for automatically determining and reversing malicious activities.

In one embodiment, an administrator of the administrative server 428A may perform a fund transfer to an external account (e.g. if a user wants to withdraw funds from his/his wallet). In this scenario, a request message may be separately routed from the wallet server 402 to the admin server 428A through the request message queue 432, where request messages may be reviewed, approved, and authorized as needed, after which the corresponding transactions are posted by the admin server 428A and executed by the wallet server 402.

In the case of multiple admin servers 428A-N, each of the admin servers 428A-N may be associated with its own elevated security privileges and/or corresponding message queues. In these embodiments, separate admin servers 428A-N may be configured to perform different sets of transactions with more sensitive transactions being accepted by the wallet server 402 only from approved admin server 428A-N or approved message queues. For example, customer service personnel accessing the admin server 428A may be authorized to approve external transfers up to a certain threshold amount, with larger transactions requiring approval by management personnel with access to the admin server 428N, and accepted by the wallet server 402 only if the appropriate response message is communicated from the admin server 428N through the response message queue 434.

In one embodiment, in addition to the method performed by the system architecture of FIG. 1, the wallet server 402 may, upon extracting the transaction request 422 from the request message 412, determine that the transaction request must be escalated and communicated to an administrative server 428A sharing the private network with the wallet server 408. The administrative server 428A may only be accessible by the wallet server 402 and only through another message broker 430 comprising another request message queue 432 and another response message queue 434. Accordingly, the wallet server 402 may generate an authorization request message and place the authorization request message in the request message queue 432 to be read by the administrative server 428A. The authorization request message may comprise an authorization request and the transaction request 422. The administrative server 428A may receive the authorization request message through the request message queue 432 and extract the authorization request and the transaction request 422 from the authorization request message. Upon determining whether the transaction of the cryptocurrency requested by the transaction request 422 is authorized, the administrative server 428A may generate an authorization response message. The authorization response message may comprise a denial of the transaction request 422 or an approval of the transaction request 422. The administrative server 428A may subsequently place the authorization response message in the response message queue 434 to be communicated to the wallet server 402.

As such, the embodiment in FIG. 4 provides for a more secure configuration of systems in which cryptocurrency transactions need to be executed automatically in response to requests arriving from the Internet 406. Separating web server 400, wallet server 402, and optional admin servers 428A-N with separate message queues (e.g. message queue 404 between the web server 400 and the wallet server 402, and message broker 430 between the wallet server 402 and the admin servers 428A-N) allows for complete physical, logical, and even geographic separation between the server that received a transaction request (e.g. web server 400) and the server that stores a cryptocurrency wallet and performs the actual transaction (e.g. wallet server 402) Since web servers must of course be exposed to the Internet and are thus naturally vulnerable, the separation of the web server 400 and the wallet server 402 significantly reduces the probability that the wallet server 402 become compromised. In addition, the system architecture of FIG. 4 allows for a controlled subset of transaction types to be executed automatically when received from the web server 400, while also requiring elevated security and approval procedures for other types of transactions. The technology also allows for different transaction types to be accepted only from specific sources, thus further increasing the security of the system architecture and reducing the possibility for unauthorized transactions.

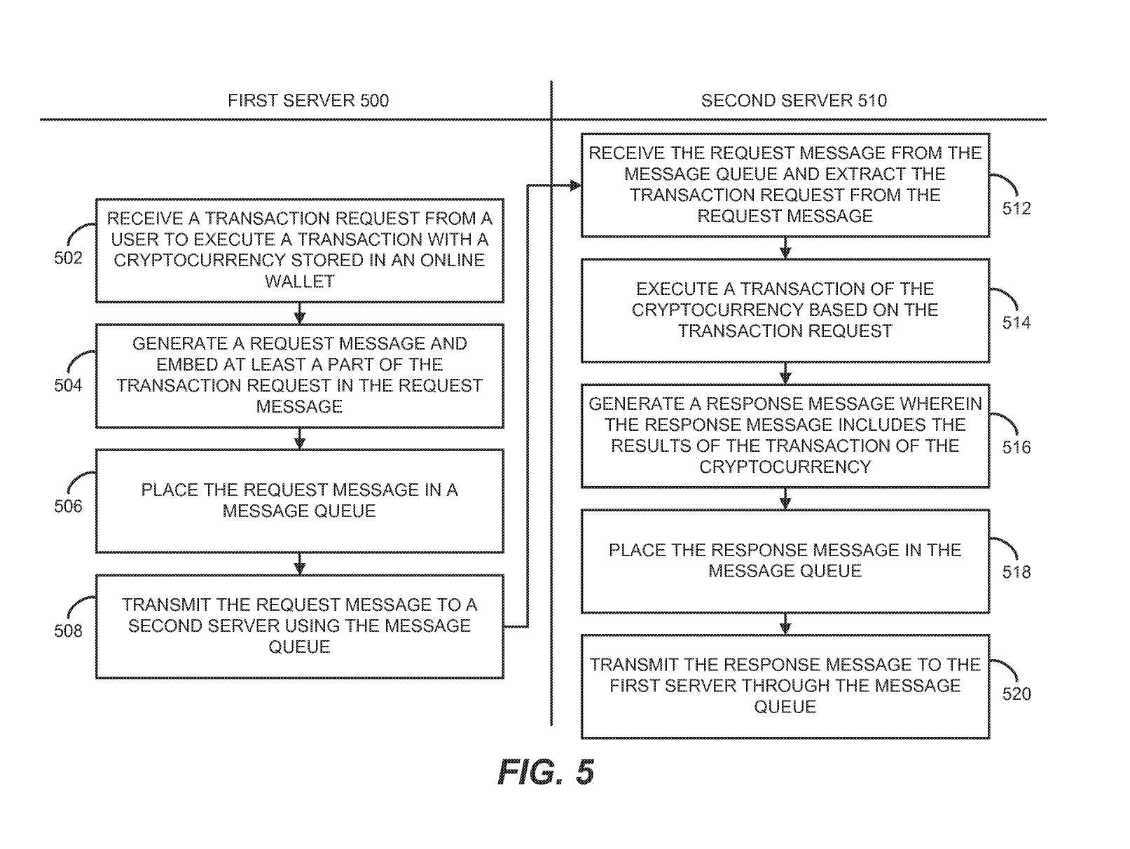

Reference is now made to FIG. 5, which is a process flowchart illustrating a method of securing cryptocurrency transactions, according to one or more embodiments. The process shown in FIG. 5 may be performed by processing logic that may comprise hardware (e.g., decision-making logic, dedicated logic, programmable logic, and microcode), software (such as software run on a general-purpose computer system or a dedicated machine), or a combination of both. In one example embodiment, the processing logic refers to one or more servers as discussed above. Notably, the below recited steps of this process may be implemented in an order different than described and shown in FIG. 5. Moreover, this process may have additional steps not shown herein, but which can be evident for those skilled in the art from the present disclosure. This process may also have fewer steps than outlined below and shown in FIG. 5. Some of the steps of this process can be optional.

In step 502, the first server 500 receives a transaction request from a user to execute a transaction with a cryptocurrency stored in an online wallet. In step 504, the first server 500 generates a request message and embeds at least a part of the transaction request in the request message. In step 506, the first server 500 places the request message in a message queue. In step 508, the first server 500 transmits the request message to a second server 510 using the message queue. In step 512, the second server 510 receives the request message from the message queue and extracts the transaction request from the request message. In step 514, the second server 510 executes a transaction of the cryptocurrency based on the transaction request. In step 516, the second server 510 generates a response message wherein the response message includes the results of the transaction of the cryptocurrency. In step 518, the second server 510 places the response message in the message queue. In step 520, the second server 510 transmits the response message to the first server 500 through the message queue.

Although the present embodiments have been described with reference to specific exemplary embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structure and methods may be embodied using transistors, logic gates, electrical circuits (e.g., application specific integrated (ASIC) circuitry and/or Digital Signal Processor (DSP) circuitry), or any combinations thereof. It should also be noted that methods disclosed herein can be implemented by one or more computers including, for example, a general-purpose computer, desktop computer, tablet computer, laptop computer, server, game console, cellular phone, smart phone, smart television system, and so forth.

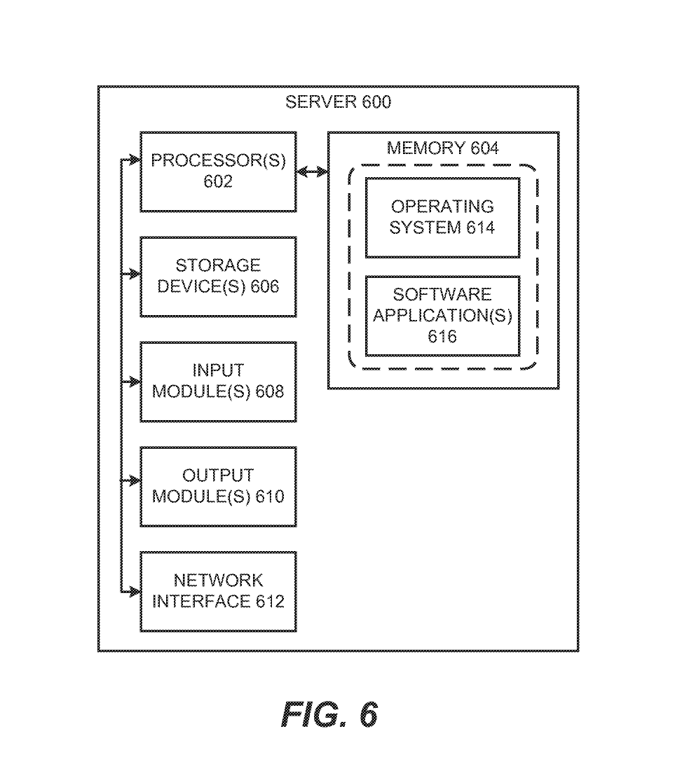

Reference is now made to FIG. 6, which is a block diagram illustrating an exemplary server architecture suitable for implementing the system and methods described herein and in the claims thereafter. Any of the components of the server 600 may include logic elements, hardware components, software (firmware) components, virtual components, or a combination thereof. Further, all modules (e.g. input module(s) 608 and/or output module(s) 610) shown in FIG. 6 may be communicatively coupled through any suitable wired, wireless, radio, electrical, or optical standards.

As shown in FIG. 6, the server 600 includes the following hardware components: one or more processors 602 (e.g. graphics processing units and/or central processing units), a memory 604, one or more storage devices 606, one or more optional input modules 608, one or more optional output modules 610, and a network interface 612. The one or more processors 602 may execute an operating system 614 stored in the memory 604 and/or one or more software applications 616 stored in the memory 604 to implement the methods disclosed herein.

In particular, the processor(s) 602 are, in some embodiments, configured to implement functionality, and/or to execute instructions within the server 600. For example, the processor(s) 602 may process instructions stored in the memory 604 and/or instructions stored on storage devices 606. Such instructions may include components of the operating system 614 and/or the software applications 606 implementing the functionality of the methods disclosed.

The memory 604, according to one exemplary embodiment, is configured to store information within the server 600 during operation of the server 600. The memory 604 may refer to a non-transitory computer-readable storage medium or a computer-readable storage device. In some examples, the memory is a temporary memory, meaning that a primary purpose of the memory may not be long-term storage. The memory 604 may also refer to a volatile memory, meaning that the memory 604 does not maintain stored contents when the memory 604 is not receiving power. Examples of volatile memories include random access memories (RAM), dynamic random access memories (DRAM), static random access memories (SRAM), and other forms of volatile memories known in the art. In some examples, the memory 604 is used to store program instructions for execution by the processor(s) 602.

One or more storage devices 606 can also include one or more transitory or non-transitory computer-readable storage media and/or computer-readable storage devices. In some embodiments, storage devices may be configured to store greater amounts of information than memory. The storage devices 606 may further be configured for long-term storage of information. In some examples, the storage devices 606 include non-volatile storage elements, meaning that the storage devices 606 may retain stored contents when the storage devices 606 are not receiving power. Examples of such non-volatile storage devices comprise magnetic hard discs, optical discs, solid-state disks, flash memories, forms of electronically programmable memories (EPROM) or electrically erasable and programmable memories, and other forms of non-volatile memories known in the art.

The server 600 also includes a network interface 612 which can be utilized to communicate with external devices, servers, and networked systems through one or more communication networks. Some examples of communications networks include wired, wireless, or optical networks including, for example, the Internet, an intranet, a LAN, a wide-area network (WAN), a cellular phone network (e.g. Global System for Mobile (GSM) communications network, packet switching communications network, circuit switching communications network), Bluetooth radio, and an IEEE 802.11-based radio frequency network. The network interface 612 may be a network interface card, such as an Ethernet card, an optical transceiver, a radio frequency transceiver, or any other type of device that can send and receive information. Other examples of such network interfaces may include Bluetooth®, 3G, 4G, and WiFi® radios in mobile computing devices as well as Universal Serial Bus (USB).

In addition, it will be appreciated that the various operations, processes and methods disclosed herein may be embodied in a non-transitory machine-readable medium and/or a machine-accessible medium compatible with a server (e.g., server 600). Accordingly, the specification and drawings are to be regarded in an illustrative rather than a restrictive sense.

A number of embodiments illustrating a system and methods for securing cryptocurrency wallets have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings are to be regarded in an illustrative rather than a restrictive sense.

What is claimed is:

1. A method for securing cryptocurrency transactions comprising:
receiving, by a first server, a transaction request of a user, the transaction request requesting execution of a transaction with a cryptocurrency stored in an online wallet;
generating, through the first server, a request message and embedding at least a part of the transaction request of the user into the request message;
placing, through the first server, the request message in a message queue managed by a message broker;
transmitting, through the first server or a computing device, the request message to a second server using the message queue, wherein the second server is accessible only through a private network and is configured to read messages from the message queue;
receiving, through the second server, the request message and extracting the transaction request from the request message;
executing, through the second server, the transaction of the cryptocurrency based on the transaction request;
generating, through the second server, a response message comprising a result of the transaction of the cryptocurrency;
placing, through the second server, the response message in the response message queue managed by the message broker; and
transmitting, through the second server or the computing device, the response message to the first server using the message broker.

2. The method of claim 1, further comprising:
upon extracting the transaction request from the request message, the second server generates an authorization request message and transmits the authorization request message to an administrative server,
wherein the administrative server is accessible only by the second server through the private network and only through a second message broker and associated message queues,
wherein the authorization request message comprises an authorization request and the transaction request;
receiving, by the administrative server, the authorization request message through the second message broker and extracting the authorization request and the transaction request from the authorization request message; and
generating, by the administrative server, an authorization response message, wherein the authorization response message comprises a denial of the transaction request or an approval of the transaction request; and
transmitting the authorization response message to the second server through the second message broker.

3. The method of claim 2, wherein the administrative server comprises a hierarchy of one or more administrative servers, each administrative server of the one or more administrative servers being authorized to receive and transmit a pre-determined subset of request messages.

4. The method of claim 2, further comprising:
recording, by the second server, the transaction request in a transaction log;
transmitting, by the second server, the transaction log to the administrative server; and
creating, by the administrative server, a request message and transmitting the request message to the second server, the request message comprising one or more reversal requests, the reversal requests configured to reverse one or more malicious transactions of cryptocurrency performed by the second server.

5. The method of claim 1, wherein the message broker and associated queues are managed by the first server.

6. The method of claim 1, wherein a message broker server configured to handle the message queues shares the private network with the second server.

7. The method of claim 1, wherein the message broker comprises:
a request queue comprising the request message; and
a response queue comprising the response message.

8. A system for securing cryptocurrency transactions comprising:
a first server, wherein the first server is configured to:
receive a transaction request from a user to execute a transaction with a cryptocurrency stored in an online wallet;
generate a request message and embed at least a part of the transaction request in the request message;
place the request message in a message queue; and
transmit the request message to a second server using the message queue;
a second server, wherein the second server is accessible only through a private network and is configured to read messages from the message queue, wherein the second server is further configured to:
receive the request message from the message queue and extract the transaction request from the request message;
execute a transaction of the cryptocurrency based on the transaction request;
generate a response message comprising a result of the transaction of the cryptocurrency;
place the response message in the message queue; and
transmit the response message to the first server through the message queue.

9. The system of claim 8, further comprising:
an administrative server accessible only by the second server through the private network and only through a second message broker, wherein the administrative server is configured to:
receive an authorization request message generated and transmitted by the second server through the second message broker,
wherein the authorization request message comprises an authorization request and the transaction request;
extract the transaction request from the request message;
generate an authorization response message, wherein the authorization response message is a denial of the transaction request or an approval of the transaction request; and
transmit the authorization response message to the second server through the second message broker.

10. The system of claim 9, wherein the administrative server comprises a hierarchy of one or more administrative servers, each administrative server of the one or more administrative servers being authorized to receive and transmit a pre-determined subset of request messages.

11. The system of claim 9, further comprising:
wherein the second system is further configured to:
record the transaction request in a transaction log;
transmit the transaction log to the administrative server; and
wherein the administrative server is further configured to:
create a request message to the second server;
transmit the request message to the second server, the request message comprising one or more reversal requests, the reversal requests configured to reverse one or more malicious transactions of cryptocurrency performed by the second server.

12. The system of claim 8, wherein the message broker is hosted by the first server.

13. The system of claim 8, further comprising a message broker server configured to manage the message queue, wherein the message broker server shares the private network with the second server.

14. The system of claim 8, wherein the message broker comprises:
a request queue comprising the request message; and
a response queue comprising the response message.

15. A method for securing cryptocurrency transactions comprising:
receiving, by a first server, a transaction request from a user, the transaction request requesting execution of a transaction of cryptocurrency stored in an online wallet;
generating, through the first server, a request message and embedding at least a part of the transaction request of the user into the request message;
placing, through the first server, the request message in a message queue;
transmitting, through the first server or a computing device, the request message to a second server using a message queue, wherein the second server is accessible only through a private network and is configured to read messages from the message queue; and
receiving, through the first server and from the second server, a response message through a message queue, wherein the response message comprises a result of the transaction.

16. The method of claim 15, further comprising:
wherein the transaction request exceeds a pre-determined threshold and requires escalation of the request message by the second server to an administrative server accessible only by the second server through the private network and only through a second message broker, and
wherein escalation of the request message comprises:
generating, through the second server, an authorization request message comprising an authorization request and the transaction request,
placing, by the second server, the authorization request message in the second message broker,
transmitting, through the second server, the authorization request message to the administrative server, and
receiving, by the second server, an authorization response message from the administrative server through the second message broker.

17. The method of claim 16, wherein the administrative server comprises a hierarchy of one or more administrative servers, each administrative server of the one or more administrative servers being authorized to receive and transmit a pre-determined subset of request messages.

18. The method of claim 15, wherein the message broker is hosted by the first server.

19. The method of claim 15, wherein a server configured to host the message broker and associated message queues shares the private network with the second server.

20. The method of claim 15, wherein the message queue comprises:
a request queue comprising the request message; and
a response queue comprising the response message.
